(19) United States
(12) Patent Application Publication
(10) Pub. No.: US 2002/0012426 A1
(43) Pub. Date: Jan. 31, 2002

(54) NO-SOLICITING SYSTEM

(76) Inventor: ROBERT E. GUPTON, MCKINNEY, TX (US)

Correspondence Address: RAYMOND VAN DYKE, JENKENS & GILCHRIST, 3200 FOUNTAIN PLACE, 1445 ROSS AVENUE, DALLAS, TX, 752022799

(21) Appl. No.: 09/193,946

(22) Filed: Nov. 18, 1998

(51) Int. Cl. H04M 3/42; H04M 3/00

(52) U.S. Cl. 379/210.02

(57) ABSTRACT

A system and method for selectively rejecting telephone calls from soliciting and telemarketing organizations is provided. A solicitor database is maintained wherein the phone numbers of soliciting and telemarketing organizations are maintained. A non-solicitation database is maintained wherein the phone numbers of subscriber who have chosen to reject calls from soliciting organizations are maintained. During a request to establish a telephone call, the solicitor database is queried to determine whether the calling party is a soliciting organization while the non-solicitation database is queried to determine if the called party has chosen to reject calls from soliciting organizations. Where the calling party is a soliciting or telemarketing organization and the called party has chosen not to receive phone calls from soliciting and telemarketing organizations, the call is blocked. Further means are provided to dynamically maintain the solicitor database, wherein a subscriber who is contacted by a soliciting or telemarketing organization can conveniently have the calling party number placed in the solicitation database.

### BACKGROUND OF THE INVENTION

1. Field of the Invention

The present invention relates generally to communication systems, and more specifically to rejecting unwanted telephone calls.

2. Description of Related Art

Traditionally, the home telephone has been an instrument for communication between individuals and their friends and families. No longer is this case. Today, a large percentage of all received phone calls are from telemarketing organizations for their own purposes, namely, trying to market a product or service or trying to obtain information. The home telephone has become an instrument for telemarketers to reach persons who might prefer to remain unknown. The home telephone is then used for its intended purpose by the one paying for it only a portion of the time.

In response to the great demand for phone company features to help stem back this form of invasion of privacy, phone companies are now offering several different subscriber features. One subscriber feature is known as caller ID. A person subscribing to caller ID utilizes a caller ID display to determine the phone number and perhaps name of the party originating an incoming call. Typically, the caller identifying information is displayed while a call is being placed and the phone is ringing. By observing the name of the party originating the call, a person subscribing to caller ID can determined whether to answer or ignore the call.

Another subscriber feature is that of anonymous call rejection. Typically, relatives and friends allow their caller ID to be displayed. Telemarketing organizations, however, frequently block their caller ID so as to prevent a called party from readily determining their phone number. By blocking the number, the calling party prevents display of the caller's ID on the called party's caller ID display. A subscriber to this feature can either selectively or perpetually have a local switch reject all anonymous calls whose caller ID is not to be shown on a called party's caller ID display.

Each of the above-mentioned features have their drawbacks. In the case of the caller ID display, a called party must look at the caller ID display to determine who is the calling party. Having to get up from the easy chair or from the dinner table often constitutes a significant portion of the aggravation experienced by the called party receiving an unwanted telephone solicitation. Additionally, caller ID requires the called party to purchase and install additional hardware along with their telephone. Furthermore, if a subscriber choosing to ignore a phone call from a telemarketer has an answering machine, the answering machine may answer the call, leaving the called party with an unwanted recorded message.

On the other hand, the problem with subscribing to the feature of anonymous call blocking is that important calls will occasionally be blocked. In addition to telemarketing organizations, a number of individuals block their caller ID, either deliberately or inadvertently. Accordingly, when one of these calls is in fact legitimate and even important to the called party, the call is still blocked.

Accordingly, it would be advantageous if a subscriber could selectively reject calls from telemarketing and soliciting organizations at the local exchange without having to purchase and install additional hardware with the telephone connection.

Therefore, it is an object of the present invention to allow a subscriber to selectively reject calls from telemarketing organizations.

It is also an object of the present invention to allow the subscriber to reject calls from telemarketing and soliciting organizations without having to purchase and install additional hardware.

### SUMMARY OF THE INVENTION

The present invention is directed to a system and method for rejecting telephone calls from soliciting and telemarketing organizations by querying a solicitor database to determine whether the calling party number is associated with a soliciting or telemarketing organization, and querying a non-solicitation database to determined whether the called party has chosen to reject calls from soliciting and telemarketing organizations. Where the calling party is a soliciting and telemarketing organization, and the called party has chosen to reject calls from soliciting and telemarketing organizations, the call is blocked.

### BRIEF DESCRIPTION OF THE DRAWINGS

Other advantages and novel features of the present invention will become apparent from the following detailed description of the invention when considered in conjunction with the accompanying drawings in which:

FIG. 1 is an exemplary telecommunications system embodying the present invention;

FIG. 2 is a flow diagram illustrating the operation of a telecommunication system in accordance with the present invention;

FIG. 3 is an exemplary telecommunications system embodying the present invention;

FIG. 4 is a flow diagram illustrating the operation of a telecommunication system in accordance with the present invention;

FIG. 5 is a flow diagram illustrating the operation of a telecommunications system in accordance with the present invention; and

FIG. 6 is a flow diagram illustrating the operation of a telecommunications system in accordance with the present invention.

### DETAILED DESCRIPTION OF PREFERRED EMBODIMENTS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

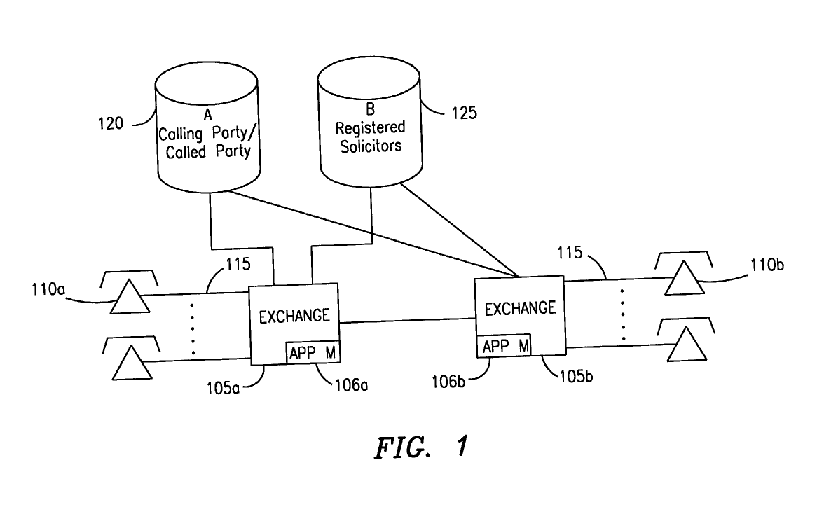

Referring now to FIG. 1, there is shown a block diagram of an exemplary telecommunications network 100 embodying the present invention. The telecommunications network 100 comprises a network of telecommunications switches 105a, 105b, each serving a plurality of telephone terminals 110. The telecommunications switch 105 comprises, for example, a local exchange or a mobile switching center. Where the telecommunications switch is a local exchange, the telephone terminal 110 comprises wireline telephonic equipment such as a wireline telephone or a computer or fax machine with either a wireline modem or an ISDN connection. Where the telecommunications switch 105 comprises a mobile switching center, the telephone terminal 110 comprises wireless telephonic equipment such as a mobile station or a computer or fax machine with a wireless modem connection. Each telephone terminal 110 is in communication with a particular telecommunications switch 105 via a communication channel 115. The communication channel 115 comprises either a land based telephone line where the telecommunications switch 105 is a local exchange or a wireless air interface where the telecommunications switch comprises a mobile switching center or a base station.

When a subscriber of telephone 110a wishes to initiate a call to a subscriber at telephone terminal 110b, telephone terminal 110a communicates a directory number associated with telephone terminal 110b to the serving telecommunications switch 105a over communications channel 115a. In a manner well known in the art, telecommunications switch 105a ascertains the telecommunications switch 105b which is associated with telephone terminal 110b. Telecommunications switch 105a and telecommunications switch 105b then coordinate to establish a voice connection between telephone terminal 110a and telephone terminal 110b. The voice connection comprises the communication channel 115a, a trunk connection connecting telecommunications switch 105a and communications switch 105b and communications channel 115b.

Traditionally, the home telephone terminal 110 has been an instrument for communication between individuals and their friends and families. No longer is this case. Today, a large percentage of all received phone calls are from telemarketing organizations for their own purposes, namely, trying to market a product or service or trying to obtain information. The home telephone terminal 110 has become an instrument for telemarketers to reach persons who might prefer to remain unknown. The home telephone is then used for its intended purpose by the one paying for it only a portion of the time.

To allow the subscriber to selectively reject incoming calls from telemarketing and soliciting organizations, the present invention proposes the addition of a solicitor database 120 and a non-solicitation database 125. The solicitor database 120 stores the directory phone numbers of telephone terminals 110 used by known soliciting and telemarketing organizations. The directory phone numbers of telephone terminals 110 used by known soliciting and telemarketing organizations can be ascertained in a number of ways. For example, a municipality may require the licensing of soliciting and telemarketing organizations, subject to penalty for violation, and make available a list of phone numbers of licensed solicitating and telemarketing organizations.

The non-solicitation database 125 stores the directory phone numbers of telephone terminals 110 associated with subscribers who prefer not to receive calls from soliciting and telemarketing organizations. The directory phone numbers of telephone terminals 110 associated with subscribers who do not wish to be contacted by soliciting and telemarketing organizations can be developed by offering a “no-solicitation service” as an optional subscriber service feature. The subscriber can register for the no-solicitation service in a manner similar to other subscriber service features, such as call-waiting, and three-way calling. The directory phone numbers of the telephone terminals 110 used by subscribers who elect the foregoing feature can then be stored in the non-solicitation database 125.

In one embodiment, both the solicitor database 120 and the non-solicitation database 125 are accessible by each of the telecommunications switches 105. Those skilled in the art will recognize that the solicitor database 120 and the non-solicitation database 125 can be integrated with, for example, a service control point (SCP) (not shown).

By adding the solicitor database 120 and the non-solicitation database 125, a telecommunications switch 105 can block calls from the telephone terminals 110, e.g., 110a, referred to in the solicitor database 120 to the telephone terminals 110, e.g. 110b, referred to in the non-solicitation database 125. During a phone call, an application module 106 causes the telecommunications switch 105 to selectively block calls by querying the solicitor database 120 using the calling party number and querying the non-solicitation database 125 using the called party number. Where the calling party number is found in the solicitor database 120 and the called party number is found in the non-solicitation database 125, the application module 106 causes the telecommunication switch 105 to block the phone call by simply halting the call establishment process.

The database queries can be performed at either the telecommunication switch 105a serving the calling party's telephone terminal 110a or by the telecommunication switch 105b serving the called party 110b. Performing the database query at the telecommunications switch 105a serving the calling party 110a is advantageous because where a call is blocked at telecommunications switch 105a, an unnecessary trunk connection connecting telecommunications switch 105a to telecommunications switch 105b is avoided. Alternatively, performing the query at the telecommunications switch 105b is advantageous because the resources serving the benefitting party 110b are utilized.

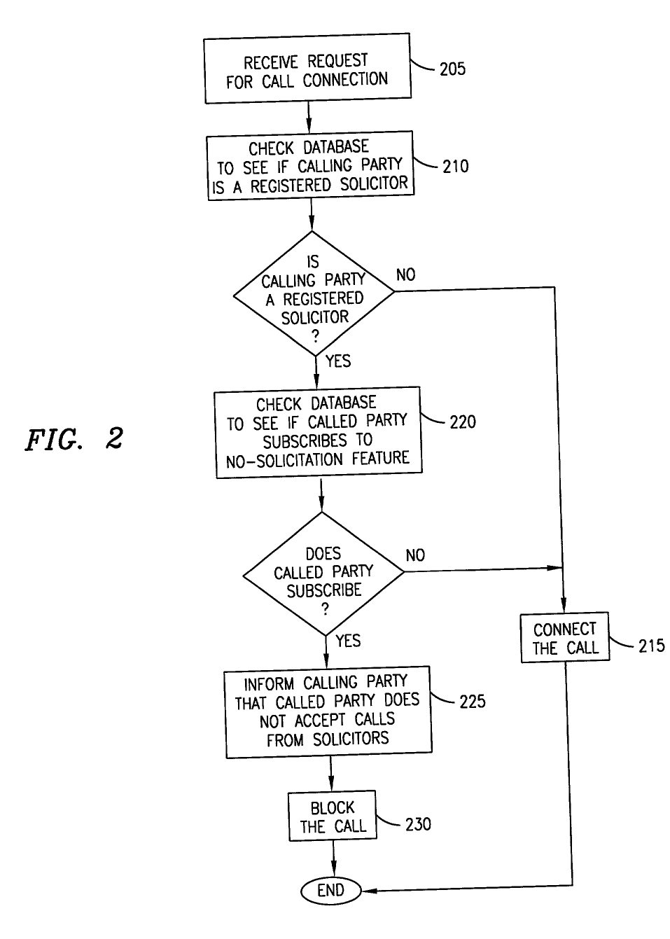

Referring now to FIG. 2, which will be described in connection with FIG. 1, there is illustrated a flow diagram describing the operation of an application module 106 during a phone call in accordance with the present invention. At step 205, telecommunications switch 105a or 105b receives a request to establish a phone call from telephone terminal 110a to telephone terminal 110b. The application module 106 responds by checking to determine if the directory phone number associated with telephone terminal 110a is listed in the solicitor database 120 (step 210). Where the directory phone number associated with telephone terminal 110a is not listed in the solicitor database 120 during step 210, the application module 106 signals the telecommunications switch 105 to connect the call (step 215) and the process is terminated. If on the other hand, the directory phone number associated with telephone terminal 110a is listed in the solicitor database 120 during step 210, the application module 106 queries the non-solicitation database 125 to determine if the phone number associated with telephone terminal 110b subscribes to the “no-solicitation service” (step 220). If the phone number associated with telephone terminal 110b is not found in the non-solicitation database 125 during step 220, the application module 106 signals the telecommunications switch 105 to connect the call (step 215), and the process is terminated. If the phone number associated with telephone terminal 110b is found in the non-solicitation database 125 during step 220, a soliciting or telemarketing organization at telephone terminal 110a is attempting to call a subscriber at telephone terminal 110b who does not wish to receive a call from the soliciting and telemarketing organizations. Therefore, the applications module 106 causes the telecommunications switch 105 to transmit a message to telephone terminal 110a that the subscriber does not wish to accept the call (step 225) and blocks the call (step 230).

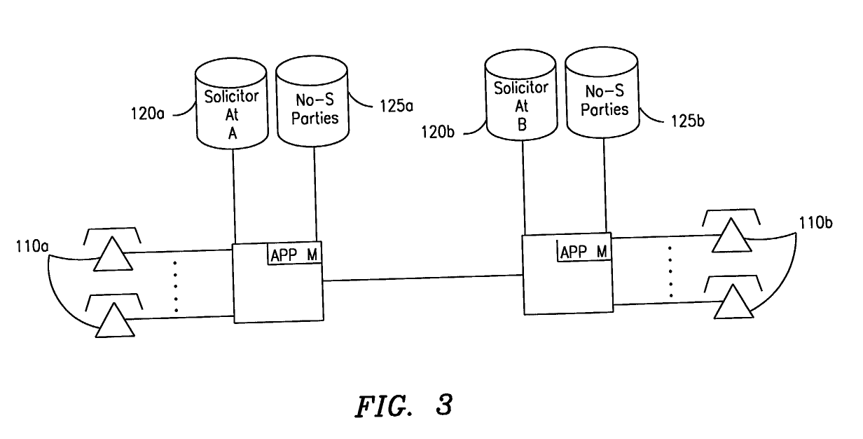

Referring now to FIG. 3, there is illustrated an alternative embodiment wherein the solicitor database 120, and the non-solicitation database 125 are implemented as local databases 120a, 120b and 125a, 125b, respectively, wherein each telecommunications switch 105 is associated with and accesses a particular solicitor database 120 and a particular non-solicitation database 125. The solicitor database 120a stores the directory phone numbers of telephone terminals 110 used by known soliciting and telemarketing organizations that are served by associated telecommunications switch 105a, while the solicitor database 120b stores the directory phone numbers of telephone terminals 110 used by known soliciting and telemarketing organizations that are served by associated telecommunications switch 105b.

The non-solicitation database 125a stores the directory phone numbers of telephone terminals 110 served by telecommunications switch 105a that are associated with subscribers who prefer not to receive calls from soliciting and telemarketing organizations, while the non-solicitation database 125b stores the directory phone numbers of telephone terminals 110 served by telecommunications switch 105b that are associated with subscribers who prefer not to receive calls from soliciting and telemarketing organizations.

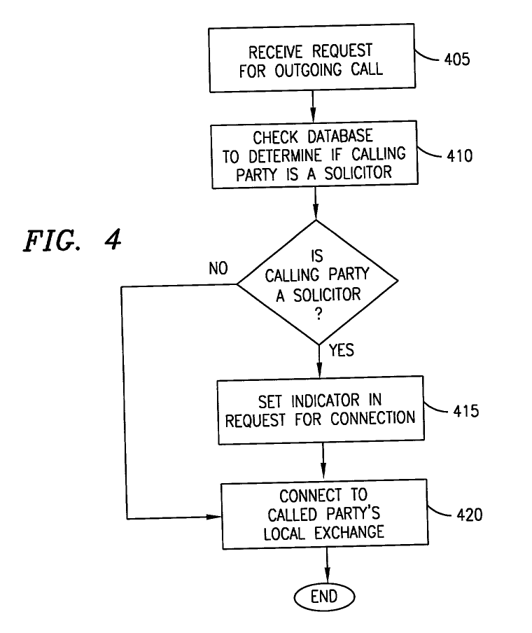

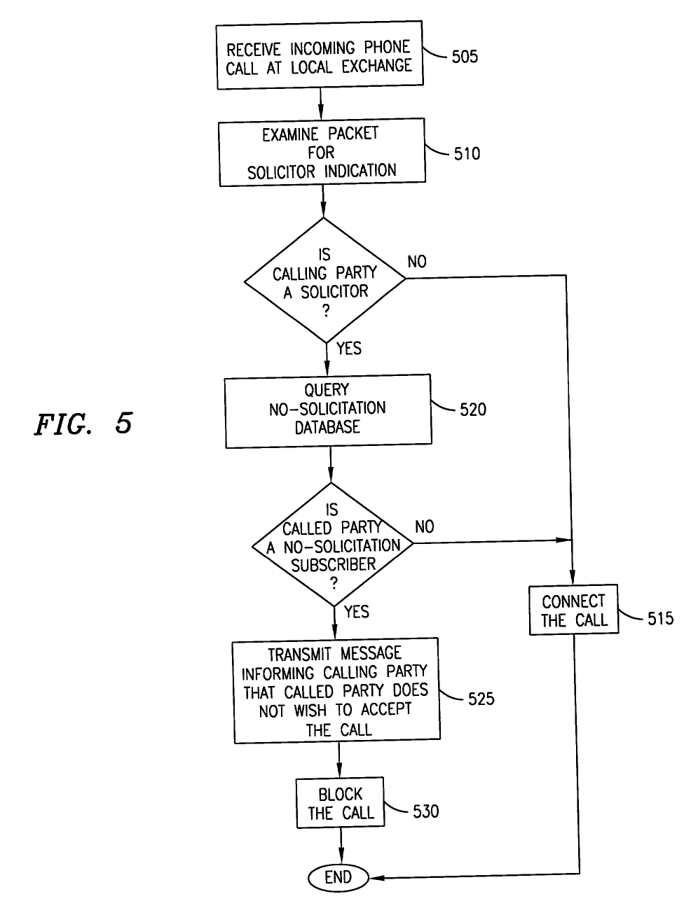

Referring now to FIGS. 4 and 5, there are illustrated flow diagrams describing the operation of the embodiment described in FIG. 3. After receiving a request to establish a phone call from, e.g., telephone terminal 110a to, e.g., telephone terminal 110b, (step 405) the application module 106a of the telecommunications switch 105a serving the calling party, telephone terminal 110a, queries the solicitor database 120a to determine if the subscriber associated with telephone terminal 110a is a soliciting or telemarketing organization (step 410). Where the calling party number, the phone number associated with telephone terminal 110a is found in the solicitor database 120a, the application module signals the telecommunications switch 105a to transmit a signal to telecommunications switch 105b indicating that the incoming call originating from telephone terminal 110a is from a soliciting or telemarketing organization (step 415). To establish a phone call, involving two or more telecommunications switches 105a, 105b, a packet of information is transmitted from the telecommunications switch 105a serving the calling party to the telecommunications switch 105b serving the called party (step 420). The signal indicating that the call originating from telephone terminal 110a is from a soliciting or telemarketing organization can be included in the packet of information that is transmitted from telecommunications switch 105a to telecommunications switch 105b.

After the telecommunications switch 105b receives the packet of information (step 505) the application module 106b of telecommunications switch 105b serving the called party can examine the packet of information transmitted from telecommunications switch 105a to determine whether the call is from a soliciting or telemarketing organization (step 510). Where the call is not from a soliciting or telemarketing organization, the application module 106b signals the telecommunications switch 105b to establish a call between telephone terminal 110a and telephone terminal 110b (step 515) and the process is terminated. On the other hand, if the packet of information indicates that the call is from a soliciting or telemarketing organization, the application module 106b queries the non-solicitation database 125b to determine whether the subscriber at telephone terminal 110b has chosen to reject calls from soliciting and telemarketing organizations (step 520). If the subscriber at telephone terminal 110b has not chosen to reject calls from soliciting and telemarketing organizations, the application module 106b signals the telecommunications switch to establish the call (step 515) and the process is terminated. However, if the subscriber at telephone terminal 110b has chosen to reject calls from soliciting and telemarketing organizations, the application module 106b signals the telecommunications switch 105b to transmit a message to telephone terminal 110a that the called party does not wish to accept the call (step 525), and blocks the call (step 530).

The foregoing represents a way for subscribers to conveniently reject unwanted calls from registered soliciting and telemarketing organizations. However, it is noted that many soliciting and telemarketing organizations might not make the appropriate data for the solicitor database 120 available, even when legally required to do so. Accordingly, it would be advantageous to provide a way to prevent or discourage unregistered soliciting and telemarketing organizations from contacting subscribers.

To prevent or discourage unregistered soliciting and telemarketing organizations from contacting subscribers, a subscriber who has chosen to reject calls from a soliciting or telemarketing organization and receives a call from an unregistered soliciting or telemarketing organization, can have the unregistered soliciting or telemarketing organization temporarily placed in the solicitor database 120 by, for example, dialing a particular subscriber feature code.

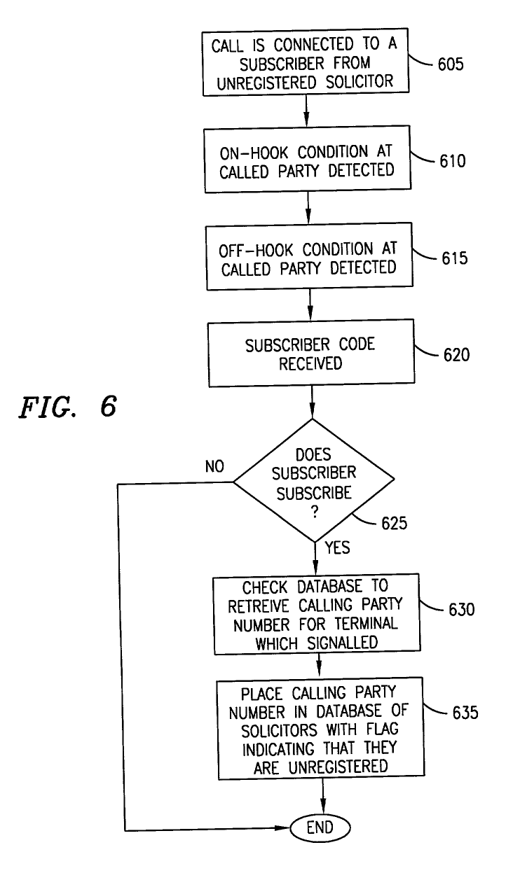

Referring now to FIG. 6, which will be described in connection with FIG. 1, there is illustrated a flow diagram describing the operation of the application module 106 when a subscriber at telephone terminal 110b who has chosen to reject calls from a soliciting or telemarketing organization and receives a call from an unregistered soliciting or telemarketing organization at telephone terminal 110a. At step 605, the subscriber at telephone terminal 110b receives a call from an unregistered soliciting or telemarketing organization at telephone terminal 110a. Because the soliciting or telemarketing organization is unregistered, the call to telephone terminal 110b is not blocked. At the completion of the phone call, the application module 106 detects that the called party has placed telephone terminal 110b in an on-hook state (step 610). Shortly thereafter, the subscriber can, for example, dial a subscriber feature code, e.g., “*99”. When the subscriber dials the subscriber feature code, the application module detects that the subscriber has placed telephone terminal 110b in an off-hook state (step 615) and that the subscriber has dialed the appropriate subscriber code (step 620). At step 625, the application module determines whether the subscriber has chosen to reject calls from soliciting or telemarketing organizations by querying the non-solicitation database 125. Where the subscriber has not chosen to reject calls from soliciting or telemarketing organizations, the process is terminated. However, where the has chosen to reject calls from soliciting or telemarketing organizations, the application module 106 retrieves the calling party number for the most recent telephone call to telephone terminal 110b, i.e., the directory phone number associated with telephone terminal 110a (step 630). Those skilled in the art will recognize that the calling party number for the most recent phone call to a particular telephone terminal 110 can be retrieved in a number of ways. For example, to support the subscriber feature known as “Subscriber Call Back”, wherein a subscriber can call back the calling party from the most recent call, the calling party number is stored in a database (not shown). Accordingly, the calling party number can be retrieved from the aforementioned database. After the directory phone number of telephone terminal 110a is retrieved, the directory phone number of telephone terminal 110a is placed in the solicitor database 120 as an unregistered soliciting or telemarketing organization and associated with a particular time limit at the expiration of which, the solicitor database 120 removes the directory phone number (step 635).

Although the invention has been described with a certain degree of particularity, it should be recognized that elements thereof may be altered by persons skilled in the art without departing from the spirit and scope of the invention. Therefore, the invention is limited only by the following claims and their equivalents.

What is claimed is:

1. A method for selectively rejecting phone calls from a first telephone terminal associated with a calling party number, said first telephone terminal served by a first telecommunication switch, to a second telephone terminal associated with a called party number, said second telephone terminal served by a second telecommunications switch, said method comprising the steps of:
querying a first database to determine whether said calling party number is stored in said first database;
querying a second database to determine whether said called party number is stored in said second database; and
rejecting said phone call from said first telephone terminal to said second telephone terminal, wherein said calling party number is stored in said first database and said called party number is stored in said second database.

2. The method of claim 1, wherein said step of querying said first database further comprises the step of querying said first database at said first telecommunications switch to determine whether said calling party number is stored in said first database.

3. The method of claim 2, wherein said step of querying said second database further comprises the step of querying said second database at said first telecommunications switch.

4. The method of claim 2, wherein said step of querying said second database further comprises the step of querying said second database at said second telecommunications switch.

5. The method of claim 1, wherein said step of querying said first database further comprises the step of querying said first database at said second telecommunications switch.

6. A method for selectively rejecting phone calls from a first telephone terminal associated with a calling party number, said first telephone terminal served by a first telecommunications switch to a second telephone terminal associated with a called party number, said second telephone terminal served by a second telecommunications switch, said method comprising the steps of:
connecting said phone call from said first telephone terminal to said second telephone terminal;
detecting an on-hook condition of said second telephone terminal;
detecting an off-hook condition of said second telephone terminal;
receiving a subscriber feature code from said second telephone terminal;
querying a first database to determine whether said called party number is stored in said first database, responsive to receiving said subscriber feature code; and
placing said calling party number in a second database wherein said called party number is stored in said first database.

7. A telecommunications system for selectively rejecting phone calls from a first telephone terminal associated with a calling party number to a second telephone terminal associated with a called party number, said telecommunications system comprising:
a first database for storing a plurality of calling party numbers;
a second database for storing a plurality of called party numbers;
a telecommunications switch for receiving a request to establish a phone call from said first telephone terminal to said second telephone terminal, said telecommunications switch comprising:
an application module for determining whether said calling party number is stored in said first database and for determining whether said called party number is stored in said second database, and wherein said calling party number is stored in said first database and said called party number is stored in said second database, causing said telecommunications switch to reject said phone call.

8. The telecommunications system of claim 7, wherein said telecommunications switch serves said first telephone terminal.

9. The telecommunications system of claim 7, wherein said telecommunications switch serves said second telephone terminal.

10. The telecommunications system of claim 7, wherein said application module further comprises means for:
connecting said phone call from said first telephone terminal to said second telephone terminal;
detecting an on-hook condition of said second telephone terminal;
detecting an off-hook condition of said second telephone terminal;
receiving a subscriber feature code from said second telephone terminal;
querying a first database to determine whether said called party number is stored in said first database, responsive to receiving said subscriber feature code; and
placing said calling party number in a second database wherein said called party number is stored in said first database.

11. A telecommunications system for selectively rejecting a phone call from a first telephone terminal associated with a calling party number to a second telephone terminal associated with a called party number, said telecommunications system comprising:
a first database for storing a plurality of calling party numbers;
a second database for storing a plurality of called party numbers;
a first telecommunications switch serving said first telephone terminal;
a second telecommunications switch serving said second telephone terminal;
a trunk connection connecting said first telecommunications switch to said second telecommunications switch;
a first application module forming a portion of said first telecommunications switch, said first application module for determining whether said calling party number is stored in said first database, and wherein said calling party number is stored in said first database, causing said first telecommunications switch to transmit a signal to said second telecommunications switch, indicating that said calling party number is stored in said first database; and
a second application module forming a portion of said second telecommunications switch, said second application module for determining whether said called party number is stored in said second database responsive to receiving said signal from said first telecommunications switch, and rejecting said phone call wherein said called party number is stored in said second database.
